(19) United States
(12) Patent Application Publication
(10) Pub. No.: US 2024/0119716 A1
(43) Pub. Date: Apr. 11, 2024

(54) METHOD FOR MULTIMODAL EMOTION CLASSIFICATION BASED ON MODAL SPACE ASSIMILATION AND CONTRASTIVE LEARNING

(71) Applicant: Hangzhou Dianzi University, Hangzhou City (CN)

(72) Inventors: Wanzeng KONG, Hangzhou City (CN); Yutao YANG, Hangzhou City (CN); Jiajia TANG, Hangzhou City (CN); Binbin NI, Hangzhou City (CN); Weicheng DAI, Hangzhou City (CN); Li ZHU, Hangzhou City (CN)

(21) Appl. No.: 18/369,672

(22) Filed: Sep. 18, 2023

(30) Foreign Application Priority Data
Sep. 19, 2022 (CN) 202211139018.0

(51) Int. Cl. G06V 10/80; G06V 10/774; G06V 10/776; G06V 20/40; G06V 40/20; G10L 15/02; G10L 15/06; G10L 15/183; G10L 25/57; G10L 25/63

(52) U.S. Cl. CPC G06V 10/811; G06V 10/774; G06V 10/776; G06V 20/41; G06V 20/46; G06V 40/20; G10L 15/02; G10L 15/063; G10L 15/183; G10L 25/57; G10L 25/63

(57) ABSTRACT

The present disclosure provides a method for multimodal emotion classification based on modal space assimilation and contrastive learning. The present disclosure introduces the concept of assimilation. A guidance vector composed of complementary information between modalities is utilized to guide each modality to simultaneously approach a solution space. This operation not only further improves the efficiency of searching for the solution space but also renders heterogeneous spaces of three modalities isomorphic. In a process of making spaces isomorphic, contributions of a plurality of modalities to a final solution space can be effectively balanced to a certain extent. When guiding each modality, this strategy enables a model to be more concerned about emotion features, thereby reducing intra-modal redundancy. Thus, the difficulty of establishing a multimodal representation is reduced.

### CROSS REFERENCE TO RELATED APPLICATION

This patent application claims the benefit and priority of Chinese Patent Application No. 202211139018.0, filed with the China National Intellectual Property Administration on Sep. 19, 2022, the disclosure of which is incorporated by reference herein in its entirety as part of the present application.

### TECHNICAL FIELD

The present disclosure belongs to the field of multimodal emotion recognition in the crossing field of natural language processing, vision, and speech, relates to a method for multimodal emotion classification based on modal space assimilation and contrastive learning, and in particular, to a method for determining a subject emotion state by assimilating a heterogeneous multimodal space using a guidance vector and constraining a multimodal representation obtained by supervised contrastive learning.

### BACKGROUND

Emotion analysis typically involves data such as text, videos, and audios. Previous studies have confirmed that such single-modal data typically contains determination information related to emotion states and have found that pure analysis of data of a single modality cannot lead to accurate emotion analysis. However, by using information of a plurality of modalities, it can be guaranteed that a model is capable of more accurate emotion analysis. Singularity and uncertainty between modalities are eliminated by means of complementarity between the modalities to effectively enhance the generalization ability and robustness of the model and improve the performance of an emotion analysis task.

An existing fusion model based on an attention mechanism is designed to establish a compact multimodal representation with information extracted from each modality and perform emotion analysis based on the multimodal representation. Therefore, such a fusion model has received attention from an increasing number of researchers. Firstly, attention coefficients between information of another two modalities (video and audio) and information of a text modality are obtained by the attention mechanism, and multimodal fusion is then performed based on the obtained attention coefficients. However, an interactive relationship between the information of a plurality of modalities is neglected. Moreover, a gap exists between modalities and there is redundancy within each modality, both of which may increase the difficulty of learning a joint embedding space. However, existing multimodal fusion methods rarely take into account the two details and do not guarantee that the information of a plurality of modalities for interaction is fine-grained, which has a certain influence on final task performance.

An existing multimodal fusion model based on a transformation network has a great advantage in terms of modeling time dependence, and a self-attention mechanism involved is capable of effectively solving the problem of non-alignment between data of a plurality of modalities. Therefore, such a multimodal fusion model has received extensive attention. The multimodal fusion model may obtain a cross-modal common subspace by transforming a distribution of a source modality into a distribution of a target modality and use the cross-modal common subspace as multimodal fused information. Moreover, a solution space is obtained by transforming the source modality into another modality. Accordingly, the solution space may be overly dependent on a contribution of the target modality, and when the data of a modality is missing, the solution space will lack a contribution of the data of the modality. This results in a failure to effectively balance the contributions of the modalities to a final solution space. In another aspect, an existing transformation model usually takes into account only transformation from a text to an audio and transformation from a text to a video, and does not take into account the possibility of transformation of other modalities, which has a certain influence on the final task performance.

Chinese patent No. CN114722202A discloses realizing multimodal emotion classification using a bidirectional double-layer attention long short-term memory (LSTM) network, where more comprehensive time dependence can be explored using the bidirectional attention LSTM network. Chinese patent No. CN113064968A provides an emotion analysis method based on a tensor fusion network, where interaction between modalities is modeled using the tensor network. However, it is hard for the two networks to effectively explore a multimodal emotion context from a long sequence, which may limit the expression ability of a learning model. Chinese patent No. CN114973062A discloses a method for multimodal emotion analysis based on a Transformer. The method uses paired cross-modal attention mechanisms to capture interaction between sequences of a plurality of modalities across different time strides, thereby potentially mapping a sequence from one modality into another modality. However, a redundant message of an auxiliary modality is neglected, which increases the difficulty of performing effective reasoning on a multimodal message. More importantly, a framework based on attention mainly focuses on static or implicit interaction between a plurality of modalities, which may result in formation of a relatively coarse-grained multimodal emotion context.

### SUMMARY

In view of the shortcomings of the prior art, a first objective of the present disclosure is to provide a method for multimodal emotion classification based on modal space assimilation and contrastive learning, where a TokenLearner module is proposed to establish a guidance vector composed by complementary information between modalities. Firstly, this module is configured to calculate a weight map for each modality based on a multi-head attention score of the modality. Each modality is then mapped into a new vector according to the obtained weight map, and an orthogonality constraint is used to guarantee that the information contained in such new vectors is complementary. Finally, a weighted average of the vectors is calculated to obtain the guidance vector. The learned guidance vector guides each modality to concurrently approach a solution space, which may render heterogeneous spaces of three modalities isomorphic. Such a strategy has no problem of an unbalanced contribution of each modality to a final solution space and is applicable to effectively explore a more complicated multimodal emotion context. To significantly improve the ability of a model to distinguish between various emotions, supervised contrastive learning is used as an additional constraint for fine adjusting the model. With the aid of label information, the model is capable of capturing a more comprehensive multimodal emotion context.

The present disclosure adopts the technical solutions as follows.

A method for multimodal emotion classification based on modal space assimilation and contrastive learning includes the following steps:
step (1), acquiring data of a plurality of modalities:
preprocessing feature information of the plurality of modalities and extracting primary representations Hₜ, Hₐ, and Hᵥ of an audio modality, a video modality, and a text modality;
step (2), establishing a TokenLearner module to obtain a guidance vector:
establishing the TokenLearner module for each modality m∈{t, a, v}, where t, a, and v represent the text, audio, and video modalities, respectively; the TokenLearner module is used repeated in each guidance; the TokenLearner module is configured to calculate a weight map based on a multi-head attention score of a modality and then obtain a new vector Zₘ according to the weight map:

$$Attention ( Q , K ) = softmax ( \frac{Q {K}^{T}}{\sqrt{{d}_{k}}} ) \qquad ( 1 )$$

$${head}_{i} = Attention ( Q {W}_{i}^{Q} , K {W}_{i}^{K} ) \qquad ( 2 )$$

$$MultiHead ( Q , K ) = \frac{1}{n} {\sum }_{i = 1}^{n} {head}_{i} \qquad ( 3 )$$

$${Z}_{m} = {α}_{m} ( MultiHead ( {H}_{m} , {H}_{m} ) ) {H}_{m} \qquad ( 4 )$$

where αₘ represents a layer of one-dimensional convolution with a softmax function being added after the convolution; Wᵢ^{Q} and Wᵢ^{K} represent weights of Q and K, respectively; dₖ represents dimensions of Hₘ; n represents a number of a plurality of heads; MultiHead(Q, K) represents the multi-head attention score; headᵢ represents an attention score of the ith head; Attention(Q, K) represents a function for calculating an attention score; the superscript T represents matrix transposition; and Q and K are two inputs to the function, namely representations Hₘ and Hₘ of modalities to which multi-head attention scores are to be calculated;
to guarantee that information in Zₘ represents complementary information of a corresponding modality, adding an orthogonality constraint to train the TokenLearner module for each modality, reducing redundant potential representations, and encouraging the TokenLearner modules to encode the plurality of modalities in different aspects;
where the orthogonality constraint is defined as:

$${ℒ}_{diff} = {\sum }_{{( {m}_{1} , {m}_{2} ) ∈}_{{\{ ( l , a ) , ( l , v ) ,}_{( a , v ) \}}}} {‖ {Z}_{{m}_{1}}^{T} {Z}_{{m}_{2}} ‖}_{F}^{2} \qquad ( 5 )$$

where ∥·∥_{F}² represents square Frobenius norm; and
calculating a weighted average of Zₘ to obtain the guidance vector Z by the following formula:

Z=⅓Σₘwₘ·Zₘ,m∈{t,a,v} (6)
where wₘ represents a weight;
step (3), guiding a modality to approach a solution space:
concurrently guiding spaces where the three modalities are located to approach the solution space according to the guidance vector Z obtained in step (2), where during each guidance, the guidance vector Z is updated in real time based on current states of the spaces where the three modalities are located; and more specifically, for the lst guidance, a post-guidance matrix for each modality is expressed as follows:

[Hₘ^{l+1},_]=Transformer([Hₘ^{l},Z^{l}];θₘ) (7)
where θₘ represents a model parameter of the Transformer module; [Hₘ^{l}, Z^{l}] represents splicing of Hₘ^{l} and Z^{l}; and the guidance of the guidance vector Z for each modality is completed by a Transformer;
expanding the formula (7) to derive:

[Hₘ^{l+1}i,_]=MLP(LN(y^{l}))+MSA(LN([Hₘ^{l},Z^{l}]))+[Hₘ^{l},Z^{l}] (8)
where MSA represents a multi-head self-attention module; LN represents a layer normalization module; and MLP represents a multilayer perceptron;
extracting last rows of data in the post-guidance matrices for the three modalities obtained after L rounds of guidance and splicing the last rows of data into a multimodal representation vector H_{final}, where L represents a maximum number of rounds of guidance;
step (4), constraining the multimodal representation vector H_{final} by supervised contrastive learning:
copying a hidden state of the multimodal representation vector H_{final} to form an augmented representation Ĥ_{final}, and removing a gradient thereof; and based on a mechanism described above, expanding N samples to obtain 2N samples, expressed as follows:

$$X = [ {H}_{final} , {\hat{H}}_{final} ] \qquad ( 10 )$$

$${ℒ}_{scl} = {\sum }_{i ∈ I} \frac{- 1}{\vert P ( i ) \vert} {\sum }_{p ∈ P ( i )} S I M ( p , i ) \qquad ( 11 )$$

$$S I M ( p , i ) = log \frac{exp ( ( {X}_{i} \cdot {X}_{p} ) / τ ) )}{{\sum }_{a ∈ A ( i )} exp ( {X}_{i} \cdot {X}_{p} / τ )} \qquad ( 12 )$$

where [symbol] _{scl} represents a loss function of supervised contrastive learning; X∈ [symbol] ^{2N×3d}, i∈I={1, 2, . . . , 2N} represents an index of any sample in a multi-view batch; τ∈R⁺ represents an adjustable coefficient for control separation of categories; P(i) is a sample set which is different from but has a same category with i, and A(i) represents all indexes other than i; and SIM( ) represents a function for calculating a similarity between samples; and
step (5), acquiring a classification result:
obtaining a final prediction ŷ for the multimodal representation vector H_{final} by a fully connected layer to realize multimodal emotion classification.

During training, prediction quality during training may be estimated using a mean square error loss:

[symbol]

ₜₐₛₖ=MAE(ŷ,y) (13)
where y represents a true label; and
an overall loss [symbol] ₒᵥₑᵣₐₗₗ is weighted by and composed of [symbol] ₜₐₛₖ, [symbol] _{diff}, and [symbol] _{scl}, expressed as follows:

[symbol]

ₒᵥₑᵣₐₗₗ=α [symbol] ₜₐₛₖ+β [symbol] _{diff}+γ [symbol] _{scl} (14)
where [symbol] ₜₐₛₖ, [symbol] _{diff}, and [symbol] _{scl} represent a loss function for an emotion classification task, a loss function for an orthogonality constraint, and a loss function for supervised contrastive learning, respectively; and α, β, and γ represent weights of [symbol] ₜₐₛₖ, [symbol] _{diff}, and [symbol] _{scl}, respectively.

A second objective of the present disclosure is to provide an electronic device, including a processor and a memory, where the memory stores machine-executable instructions capable of being executed by the processor, and the processor is configured to execute the machine-executable instructions to implement the method.

A third objective of the present disclosure is to provide a machine-readable storage medium, storing machine-executable instructions which, when called and executed by a processor, cause the processor to implement the method.

The present disclosure has following beneficial effects:

The present disclosure introduces the concept of assimilation. A guidance vector is utilized to guide a space where each modality is located to simultaneously approach a solution space so that the heterogeneous spaces of modalities can be assimilated. Such a strategy has no problem of an unbalanced contribution of each modality to a final solution space and is applicable to effectively explore a more complicated multimodal emotion context. Meanwhile, a steering vector guiding a single modality is composed of complementary information between a plurality of modalities, which enables the model to be more concerned about emotion features. Thus, intra-modal redundancy that may increase the difficulty of obtaining a multimodal representation can be naturally removed.

By combining a dual learning mechanism with a self-attention mechanism, in a process of transforming one modality into another modality, directional long-term interactive cross-modal fused information between a modality pair is mined. Meanwhile, the dual learning technique is capable of enhancing the robustness of the model and thus can well cope with the inherent problem (i.e., modal data missing problem) in multimodal learning. Next, a hierarchical fusion framework is constructed on this basis to splice all cross-modal fused information having a same source modality together. Further, a one-dimensional convolutional layer is used to perform high-level multimodal fusion. This is an effective complement for the existing multimodal fusion framework in the field of emotion recognition. Moreover, supervised contrastive learning is introduced to help the model with identifying differences between different categories, thereby achieving the purpose of improving the ability of the model to distinguish between different emotions.

### BRIEF DESCRIPTION OF THE DRAWINGS

FIG. 1 is a flowchart of the present disclosure;

FIG. 2 is an overall schematic diagram of step 3 of the present disclosure; and

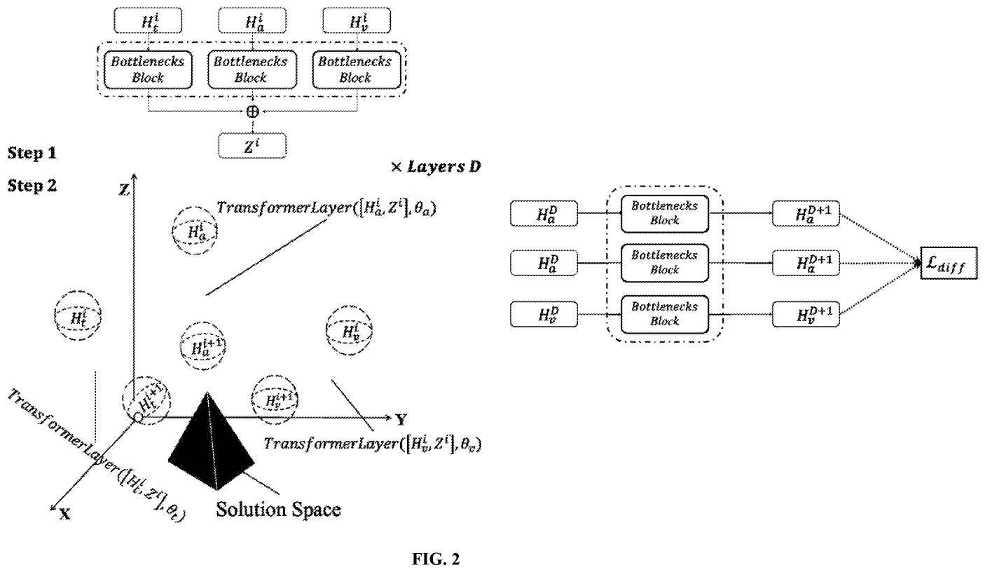

FIG. 3 is a schematic diagram of a fusion frame of the present disclosure.

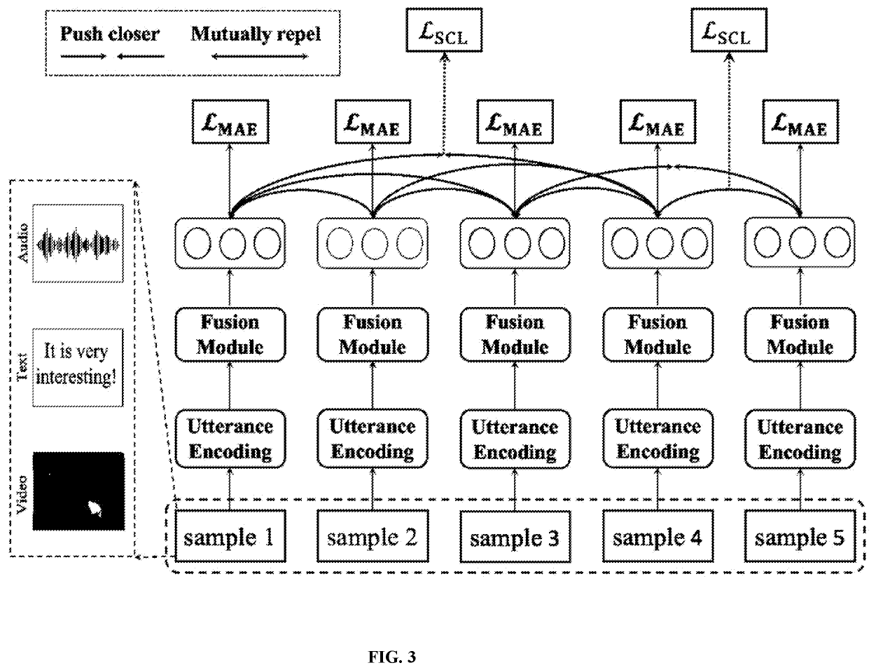

### DETAILED DESCRIPTION OF THE EMBODIMENTS

The present disclosure is described in detail below with reference to the accompanying drawings.

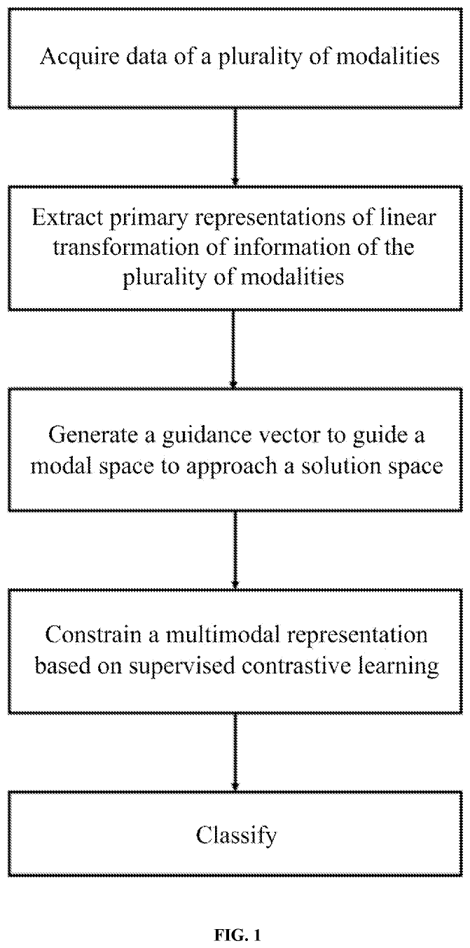

A method for multimodal emotion classification based on modal space assimilation and contrastive learning provided in the present disclosure, as shown in FIG. 1, includes the following steps.

Step 1, information data of a plurality of modalities is acquired.

Data of a plurality of modalities of a subject is recorded when the subject performs a particular emotion task. The plurality of modalities include a text modality, an audio modality, and a video modality.

Step 2, the information data of the plurality of modalities is preprocessed.

A primary feature is extracted from each modality through a particular network:
Bidirectional Encoder Representations from Transformers (BERT) are adopted for the text modality; and
a Transformer is adopted for the audio modality and the video modality:

Hₜ=BERT(T)

Hₐ=Transformer(A)

Hᵥ=Transformer(V) (1)
where Hₘ∈ [symbol] ^{T}^{ₘ}^{×d}^{ₘ} represents a primary representation of the mth modality, m∈{t, a, v}; t, a, and v represent the text, audio, and video modalities, respectively; T, A, and V represent original data of the text, audio, and video modalities, respectively; Tₘ represents a size in a time-domain dimension; and dₘ represents a length of a feature vector at each point of time.

Step 3, a guidance vector is established to guide a modal space.

In the proposed multimodal fusion framework, a TokenLearner module is one of core processing modules. During multimodal fusion, this module is designed for each modality to extract complementary information between modalities, whereby a guidance vector is established to simultaneously guide each modal space to approach a solution space. This guarantees that a contribution of each modality to a final solution space is identical.

Firstly, a multi-head attention score matrix MultiHead(Q, K) of each modality is calculated based on the data Hₘ(m∈{l, a, v}) of the plurality of modalities. One-dimensional convolution is then carried out for the matrix and a softmax function is added after the convolution, whereby a weight matrix is obtained. A number of rows of the weight matrix is far less than a number of rows of Hₘ(m∈{l, a, v}). The weight matrix is multiplied by the data Hₘ(m∈{l, a, v} of the plurality of modalities to extract information Zₘ(m∈{l, a, v}):

$$Attention ( Q , K ) = softmax ( \frac{Q {K}^{T}}{\sqrt{{d}_{k}}} ) \qquad ( 2 )$$

$${head}_{i} = Attention ( Q {W}_{i}^{Q} , K {W}_{i}^{K} ) \qquad ( 3 )$$

$$MultiHead ( Q , K ) = \frac{1}{n} {\sum }_{i = 1}^{n} {head}_{i} \qquad ( 4 )$$

$${Z}_{m} = {A}_{m} {H}_{m} = {α}_{m} ( MultiHead ( {H}_{m} , {H}_{m} ) ) {H}_{m} \qquad ( 5 )$$

where Attention(Q, K) represents a function for calculating an attention score; the superscript T represents transposition; and dₖ represents dimensions of Hₘ.

A weighted average of Zₘ(m∈{l, a, v}) containing the complementary information between modalities is calculated to establish the guidance vector Z in a current state.

$$Z = \frac{1}{3} {\sum }_{m} {w}_{m} \cdot {Z}_{m} , m ∈ \{ t , a , v \} \qquad ( 6 )$$

$$[ {H}_{m}^{l + 1} , \_ ] = Transformer ( [ {H}_{m}^{l} , {Z}^{l} ] ; {θ}_{m} ) \qquad ( 7 )$$

Step 3 will be repeated for a plurality of times, and a new guidance vector Z will be generated each time according to the current state of each modality to guide the modal space to approach the final solution space. Meanwhile, to guarantee that the information extracted by the TokenLearner module is complementary between modalities, we finally used an orthogonality constraint to train three TokenLearner modules:

$${ℒ}_{diff} = {\sum }_{{( {m}_{1} , {m}_{2} ) ∈}_{{\{ ( l , a ) , ( t , v ) ,}_{( a , v ) \}}}} {‖ {Z}_{{m}_{1}}^{T} {Z}_{{m}_{2}} ‖}_{F}^{2} \qquad ( 6 )$$

Step 4, pre-training continues.

Based on step 3, after guiding for a plurality of times, we extracted the last elements of the data Hₘ(m∈{l, a, v}) of the plurality of modalities and integrated them into a compact multimodal representation H_{final}. To enable the model to distinguish between various emotions more easily, we introduced supervised contrastive learning to constrain the multimodal representation H_{final}. This strategy introduces label information. In the case of fully utilizing the label information, samples of a same emotion are pushed closer, and samples of different emotions mutually repel. Finally, final fused information is input to a linear classification layer, and output information is compared with an emotion category label to obtain a final classification result.

The present disclosure is compared with some fusion methods with excellent effects on two disclosed multimodal emotion databases: CMU multimodal opinion sentiment intensity (CMU-MOSI) and CMU multimodal opinion sentiment and emotion intensity (CMU-MOSEI), where the CMU-MOSI dataset is composed of 2199 video clips collected from 93 opinion videos downloaded from Youtube. Opinions of 89 different narrators on some topics are included. Each video clip is manually marked with an emotional intensity from −3 (strong negative) to 3 (strong positive).

Results in Table 1 are related to mean absolute error (MAE), correlation coefficient Corr, accuracy Acc-2 corresponding to an emotional binary classification task, F1 score F1-Score, and accuracy Acc-7 corresponding to an emotional seven-way classification task. Although Self-MM is superior to other existing methods, the advantages and effectiveness of the present disclosure still can be observed in Table 1. On the CMU-MOSI dataset, the present disclosure is superior to the most advanced Self-MM on all indicators. Moreover, on the CMU-MOSEI dataset, the present disclosure is superior to Self-MM, and has an increase of about 0.8% in Acc2 and an improvement of 0.9% on F1-Score. Therefore, the effectiveness of the method provided in the present disclosure has been proven.

TABLE 1
Comparison of Results

| | CMU-MOSI | | | | | CMU-MOSEI | | | | |
|---|---|---|---|---|---|---|---|---|---|---|
| models | MAE | Corr | Acc-7 | Acc-2 | F1 | MAE | Corr | Acc-7 | Acc-2 | F1 |
| TFN | 0.901 | 0.698 | 34.9 | —/80.8 | —/80.7 | 0.593 | 0.700 | 50.2 | —/82.5 | —/82.1 |
| LMF | 0.917 | 0.695 | 33.2 | —/82.5 | —/82.4 | 0.623 | 0.677 | 48.0 | —/82.0 | —/82.1 |
| ICCN | 0.862 | 0.714 | 39.0 | —/83.0 | —/83.0 | 0.565 | 0.713 | 51.6 | —/84.2 | —/84.2 |
| MFM | 0.877 | 0.706 | 35.4 | —/81.7 | —/81.6 | 0.568 | 0.717 | 51.3 | —/84.4 | —/84.3 |
| MulT | 0.861 | 0.711 | — | 81.5/84.1 | 80.6/83.9 | 0.580 | 0.703 | — | —/82.5 | —/82.3 |
| MISA | 0.804 | 0.764 | — | 80.79/82.10 | 80.77/82.03 | 0.568 | 0.724 | — | 82.59/84.23 | 82.67/83.97 |
| MAG - BERT | 0.731 | 0.789 | — | 82.5/84.3 | 82.6/84.3 | 0.539 | 0.753 | — | 83.8/85.2 | 83.7/85.1 |
| Self - MM | 0.713 | 0.798 | — | 84.00/85.98 | 84.42/85.95 | 0.530 | 0.765 | — | 82.81/85.17 | 82.53/85.30 |
| Present | 0.708 | 0.805 | 0.464 | 84.53/86.80 | 84.67/86.87 | 0.591 | 0.793 | 53.2 | 83.37/86.0 | 83.61/85.90 |
| disclosure | | | | | | | | | | |

1-12. (canceled)

13. A method for multimodal emotion classification based on modal space assimilation and contrastive learning, comprising the following steps:
step (1), acquiring data of a plurality of modalities:
preprocessing feature information of the plurality of modalities and extracting primary representations Hₜ, Hₐ, and Hᵥ of an audio modality, a video modality, and a text modality;
step (2), establishing a TokenLearner module to obtain a guidance vector:
establishing the TokenLearner module for each modality m∈{t, a, v}, wherein t, a, and v represent the text, audio, and video modalities, respectively; the TokenLearner module is used repeated in each guidance; the TokenLearner module is configured to calculate a weight map based on a multi-head attention score of a modality and then obtain a new vector Zₘ according to the weight map:
$$Attention ( Q , K ) = softmax ( \frac{Q {K}^{T}}{\sqrt{{d}_{k}}} ) \qquad ( 1 )$$
$${head}_{i} = Attention ( Q {W}_{i}^{Q} , K {W}_{i}^{K} ) \qquad ( 2 )$$
$$MultiHead ( Q , K ) = \frac{1}{n} {\sum }_{i = 1}^{n} {head}_{i} \qquad ( 3 )$$
$${Z}_{m} = {α}_{m} ( MultiHead ( {H}_{m} , {H}_{m} ) ) {H}_{m} \qquad ( 4 )$$
wherein αₘ represents a layer of one-dimensional convolution with a softmax function being added after the convolution; Wᵢ^{Q} and Wᵢ^{K} represent weights of Q and K, respectively; dₖ represents dimensions of Hₘ; n represents a number of a plurality of heads; and
MultiHead(Q, K) represents the multi-head attention score; headᵢ represents an attention score of the ith head; and Attention(Q, K) represents a function for calculating an attention score;
to guarantee that information in Zₘ represents complementary information of a corresponding modality, adding an orthogonality constraint to train the TokenLearner module for each modality, reducing redundant potential representations, and encouraging the TokenLearner modules to encode the plurality of modalities in different aspects;
wherein the orthogonality constraint is defined as:
$${ℒ}_{diff} = {\sum }_{{( {m}_{1} , {m}_{2} ) ∈}_{{\{ ( l , a ) , ( l , v ) ,}_{( a , v ) \}}}} {‖ {Z}_{{m}_{1}}^{T} {Z}_{{m}_{2}} ‖}_{F}^{2} \qquad ( 5 )$$
wherein ∥·∥_{F}² represents square Frobenius norm; and
calculating a weighted average of Zₘ to obtain the guidance vector Z by the following formula:
Z=⅓Σₘwₘ·Zₘ,m∈{t,a,v} (6)
wherein wₘ represents a weight;
step (3), guiding a modality to approach a solution space:
concurrently guiding spaces where the three modalities are located to approach the solution space according to the guidance vector Z obtained in step (2), wherein during each guidance, the guidance vector Z is updated in real time based on current states of the spaces where the three modalities are located; and more specifically, for the lth guidance, a post-guidance matrix for each modality is expressed as follows:
[Hₘ^{l+1},_]=Transformer([Hₘ^{l},Z^{l}];θₘ) (7)
wherein θₘ represents a model parameter of the Transformer module; [Hₘ^{l}, Z^{l}] represents splicing of Hₘ^{l} and Z^{l}; and the guidance of the guidance vector Z for each modality is completed by a Transformer;
expanding the formula (7) to derive:
[Hₘ^{l+1},_]=MLP(LN(y^{l}))+MSA(LN([Hₘ^{l},Z^{l}]))+[Hₘ^{l},Z^{l}] (8)
wherein MSA represents a multi-head self-attention module; LN represents a layer normalization module; and MLP represents a multilayer perceptron;
extracting last rows of data in the post-guidance matrices for the three modalities obtained after L rounds of guidance and splicing the last rows of data into a multimodal representation vector H_{final}, wherein L represents a maximum number of rounds of guidance;
step (4), constraining the multimodal representation vector H_{final} by supervised contrastive learning:
copying a hidden state of the multimodal representation vector H_{final} to form an augmented representation Ĥ_{final}, and removing a gradient thereof, and based on a mechanism described above, expanding N samples to obtain 2N samples, expressed as follows:
$$X = [ {H}_{final} , {\hat{H}}_{final} ] \qquad ( 10 )$$
$${ℒ}_{scl} = {\sum }_{i ∈ I} \frac{- 1}{\vert P ( i ) \vert} {\sum }_{p ∈ P ( i )} S I M ( p , i ) \qquad ( 11 )$$
$$S I M ( p , i ) = log \frac{exp ( ( {X}_{i} \cdot {X}_{p} ) / τ ) )}{{\sum }_{a ∈ A ( i )} exp ( {X}_{i} \cdot {X}_{p} / τ )} \qquad ( 12 )$$
wherein [symbol] _{scl} represents a loss function of supervised contrastive learning; X∈ [symbol] ^{2N×3d}, [symbol] i∈I={1, 2, . . . , 2N} represents an index of any sample in a multi-view batch; τ∈R⁺ represents an adjustable coefficient for control separation of categories; P(i) is a sample set which is different from but has a same category with i, and A(i) represents all indexes other than i; and SIM( ) represents a function for calculating a similarity between samples; and
step (5), acquiring a classification result:
obtaining a final prediction ŷ for the multimodal representation vector H_{final} by a fully connected layer to realize multimodal emotion classification.

14. The method according to claim 13, wherein during training, prediction quality during training is estimated using a mean square error loss: [symbol]
ₜₐₛₖ=MAE(ŷ,y) (13)
wherein y represents a true label; and
an overall loss [symbol] ₒᵥₑᵣₐₗₗ is weighted by and composed of [symbol] ₜₐₛₖ, [symbol] _{diff}, and [symbol] _{scl}, expressed as follows: [symbol]
ₒᵥₑᵣₐₗₗ=α [symbol] ₜₐₛₖ+β [symbol] _{diff}+γ [symbol] _{scl} (14)
wherein [symbol] ₜₐₛₖ, [symbol] _{diff}, and [symbol] _{scl} represent a loss function for an emotion classification task, a loss function for an orthogonality constraint, and a loss function for supervised contrastive learning, respectively; and α, β, and γ represent weights of [symbol] ₜₐₛₖ, [symbol] _{diff}, and [symbol] _{scl}, respectively.

15. The method according to claim 13, wherein a Bidirectional Encoder Representations from Transformers (BERT) model is employed for preprocessing the text modality in step (1).

16. The method according to claim 13, wherein a Transformer model is employed for preprocessing the audio modality and the video modality in step (1).

17. An electronic device, comprising a processor and a memory, wherein the memory stores machine-executable instructions capable of being executed by the processor, and the processor is configured to execute the machine-executable instructions to implement the method according to claim 13.

18. The electronic device according to claim 17, wherein during training, prediction quality during training is estimated using a mean square error loss: [symbol]
ₜₐₛₖ=MAE(ŷ,y) (13)
wherein y represents a true label; and
an overall loss [symbol] ₒᵥₑᵣₐₗₗ is weighted by and composed of [symbol] ₜₐₛₖ, [symbol] _{diff}, and [symbol] _{scl}, expressed as follows: [symbol]
ₒᵥₑᵣₐₗₗα [symbol] ₜₐₛₖ+β [symbol] _{diff}+γ [symbol] _{scl} (14)
wherein [symbol] ₜₐₛₖ, [symbol] _{diff}, and [symbol] _{scl} represent a loss function for an emotion classification task, a loss function for an orthogonality constraint, and a loss function for supervised contrastive learning, respectively; and α, β, and γ represent weights of [symbol] ₜₐₛₖ, [symbol] _{diff}, and [symbol] _{scl}, respectively.

19. The electronic device according to claim 17, wherein a Bidirectional Encoder Representations from Transformers (BERT) model is employed for preprocessing the text modality in step (1).

20. The electronic device according to claim 17, wherein a Transformer model is employed for preprocessing the audio modality and the video modality in step (1).

21. A machine-readable storage medium, storing machine-executable instructions which, when called and executed by a processor, cause the processor to implement the method according claim 13.

22. The machine-readable storage medium according to claim 21, wherein during training, prediction quality during training is estimated using a mean square error loss: [symbol]
ₜₐₛₖ=MAE(ŷ,y) (13)
wherein y represents a true label; and
an overall loss [symbol] ₒᵥₑᵣₐₗₗ is weighted by and composed of [symbol] ₜₐₛₖ, [symbol] _{diff}, and [symbol] _{scl}, expressed as follows: [symbol]
ₒᵥₑᵣₐₗₗ=α [symbol] ₜₐₛₖ+β [symbol] _{diff}+γ [symbol] _{scl} (14)
wherein [symbol] ₜₐₛₖ, [symbol] _{diff}, and [symbol] _{scl} represent a loss function for an emotion classification task, a loss function for an orthogonality constraint, and a loss function for supervised contrastive learning, respectively; and α, β, and γ represent weights of [symbol] ₜₐₛₖ, [symbol] _{diff}, and [symbol] _{scl}, respectively.

23. The machine-readable storage medium according to claim 21, wherein a Bidirectional Encoder Representations from Transformers (BERT) model is employed for preprocessing the text modality in step (1).

24. The machine-readable storage medium according to claim 21, wherein a Transformer model is employed for preprocessing the audio modality and the video modality in step (1).
